(19) United States
(12) Patent Application Publication
(10) Pub. No.: US 2009/0113871 A1
(43) Pub. Date: May 7, 2009

(54) ROTORCRAFT FITTED WITH TURBINE ENGINES

(75) Inventor: Bernard CERTAIN, AIX EN PROVENCE (FR)

Correspondence Address: YOUNG & THOMPSON, 209 Madison Street, Suite 500, ALEXANDRIA, VA, 22314, US

(73) Assignee: EUROCOPTER, Marignane Cedex (FR)

(21) Appl. No.: 12/257,436

(22) Filed: Oct. 24, 2008

(30) Foreign Application Priority Data
Oct. 26, 2007 (FR) 07 07547

(51) Int. Cl. F02C 3/04

(52) U.S. Cl. 60/39.43

(57) ABSTRACT

The invention relates to a rotorcraft (10) having a main rotor (11), a turbine engine (13), and a transmission mechanism (MGB) coupled to the rotor and to the engine to enable the engine to drive the rotor. The engine has a free turbine (132) connected to the transmission mechanism (MGB) by a shaft (15, 15a, 15b, 16, 18). The rotorcraft includes an external compressor (19) arranged to be driven by the free turbine (132) or by an electric motor, together with an air-transport duct (21) connecting the external compressor (19) to the engine so as to deliver the air that has been compressed by the external compressor to the inlets (22) of the engine.

The present invention relates to improvements provided to rotorcraft fitted with one or more turbine engines.

The technical field of the invention is that of helicopter manufacture.

### BACKGROUND OF THE INVENTION

A rotorcraft has at least one rotor fitted with blades, sometimes referred to as the main rotor, that serves on being rotated to provide the rotorcraft with lift and propulsion.

A rotorcraft also has one, two, or three engines serving to drive the main rotor, and possibly an anti-torque rotor, and also various accessories (alternator and pump(s) in particular).

A transmission mechanism, also known as a main gearbox (MGB) acts to connect an outlet shaft from the engine to the shaft of the main rotor, the transmission mechanism including in particular a speed reducer. Such mechanisms are described by way of example in patents U.S. Pat. No. 3,002,710, U.S. Pat. No. 3,255,825, and U.S. Pat. No. 4,811,627.

Each engine has an axial and/or centrifugal compressor that generally comprises a plurality of wheels forming a corresponding number of compression stages, together with a first turbine that is constrained to rotate with the compressor; the engine also has a second turbine, known as a power turbine or a free turbine, that lies downstream from the first turbine in the direction of gas flow through the engine, and that is generally on the same axis.

The free turbine is mounted to rotate freely relative to the first turbine and serves to transform the thrust exerted by the gas on its blades into a “driving” mechanical torque; this driving torque is transmitted by the shaft of the free turbine and then via a speed reducer that is generally incorporated in the engine, and by an outlet shaft from the engine that may extend beside and outside the engine, e.g. parallel to the common axis of rotation of the compressor and the first and second turbines.

The driving power needed for driving a rotorcraft varies greatly depending on the performance expected of the rotorcraft and depending on the environment, in particular the speed in translation of the rotorcraft, its on-board weight, ambient temperature, atmospheric pressure, and/or altitude.

Furthermore, the power delivered by a turbine engine varies considerably with varying atmospheric pressure and/or altitude, in particular.

Matching an existing helicopter to requirements/missions that require a higher level of power can be achieved to some extent and under certain circumstances by adding an engine and by modifying the power transmission mechanism accordingly; however in order to modify the transmission mechanism that requires specific design, development, and testing are required, and that is lengthy and expensive.

That technique also tends towards providing engines of lower unit power, but unfortunately their specific fuel consumption is then greater than that of engines of high unit power.

Furthermore, the design, development, and testing of an engine of suitable power, in particular of high power, are likewise operations that are lengthy and expensive.

### OBJECT AND SUMMARY OF THE INVENTION

An object of the invention is to propose a remedy, at least in part, to this situation.

In an aspect of the invention, it is proposed to fit a rotorcraft with an additional external air compressor that is separated from—i.e. external to—the turbine engine, together with an air-transport duct connecting the outlet from the external compressor to the inlet of the engine in order to supply the engine inlet with air that has been compressed by the external compressor.

The invention enables the mechanical power delivered by the engine(s) to be increased without modifying the engine(s) by increasing the air pressure that obtains at the inlet to the internal compressor incorporated in the engine(s), as is achieved by the external compressor outside the engine(s).

Preferably, under normal conditions of temperature and pressure, and at its normal speed of rotation, the external compressor presents a compression ratio lying in the range about 1.01 to about 2, and in particular situated in the range about 1.05 to about 1.5.

In a preferred embodiment, the external compressor comprises a single bladed moving wheel, i.e. has only one stage, and is of the axial wheel type. In other embodiments, the external compressor may have a plurality of axial and/or centrifugal wheels, i.e. a plurality of stages.

The external compressor wheel(s) may incorporate means enabling the pitch of the blades to be varied so as to make it possible to vary the amount of compression that is obtained.

The external compressor is arranged to be driven directly or indirectly by the engine; for this purpose, the external compressor may be arranged to be driven by the free turbine, where appropriate via a speed reducer and/or a transmission shaft, or by the main transmission mechanism (MGB) of the rotorcraft, or it may be arranged to be driven by an electric motor, itself drawing power that comes from the engine or from the MGB via a generator—such as an alternator—and a battery.

With electrical drive, in particular, the external compressor may include a device for varying its speed of rotation, which device thus serves to vary the amount of compression obtained.

Also preferably, the rotorcraft further includes a heat exchanger disposed in the air-transport duct connecting the external compressor to the engine; the heat exchanger is connected to a circuit for transporting a fluid (water, air, oil, cooling fluid), with circulation of said fluid through the heat exchanger serving to cool the air that has been compressed by the external compressor.

In a particular embodiment, the turbine engine may have two outlet shafts: a first shaft that may lie on the same axis as the shaft common to the internal compressor and to the first turbine of the engine, and that may extend inside the common shaft, which first shaft may be used for driving a propulsion propeller and/or the external compressor; and a second shaft that can be used to drive the main rotor of the rotorcraft via the MGB mechanism.

In particular when the external compressor is driven by the MGB, it may be situated in front thereof (“front” with reference to the forward direction of the rotorcraft). In contrast, in particular when the external compressor is driven by an outlet shaft of the engine, it may be situated behind the MGB.

A rotorcraft having two engines may have a single external compressor that delivers pressurized air to both engines, or it may have two external compressors feeding the two engines, respectively.

In either configuration, the air compressed by the external compressor(s) may be delivered to both engines, or else to only one of them.

A motor-driven damper may be located in the air-transport duct(s) connecting the external compressor(s) to the engines.

The invention enables the specific consumption of a rotorcraft to be reduced while cruising.

The invention provides a system that is simple, inexpensive, and compact that enables the driving power delivered by a rotorcraft engine to be increased.

### BRIEF DESCRIPTION OF THE DRAWINGS

Other aspects, characteristics, and advantages of the invention appear in the following description given with reference to the accompanying drawings that show preferred embodiments of the invention without any limiting character.

FIG. 1 is a simplified diagram showing a rotorcraft turbine engine and an external “supercharger” compressor for the turbine engine, which compressor is driven by the engine in a first embodiment of the invention.

FIG. 2 is a diagrammatic plan view of a rotorcraft fitted with two turbine engines and with an external pressurizing compressor that is common to both engines, in another embodiment of the invention.

FIG. 3 is a diagrammatic side view of another embodiment of the invention.

FIG. 4 is a diagrammatic plan view of another embodiment of the invention in which a rotorcraft is fitted with two turbine engines and with two external compressors.

FIG. 5 is a diagrammatic perspective view of a power transmission mechanism between two respective outlet shafts of two turbine engines (not shown) and a rotorcraft lift rotor, together with two external compressors and their respective drive mechanisms for being driven by the engines and/or by the MGB, in another embodiment of the invention.

FIG. 6 is a diagrammatic perspective view showing how two external compressors are installed in two air feed ducts for two turbine engines of a rotorcraft, in another embodiment of the invention.

### MORE DETAILED DESCRIPTION

With reference to FIGS. 2 to 6, the invention relates to helicopters 10 and other rotorcraft in which at least one lift and propulsion rotor 11 having blades 12 is driven in rotation about a substantially vertical axis 14 by one or more turbine engines 13.

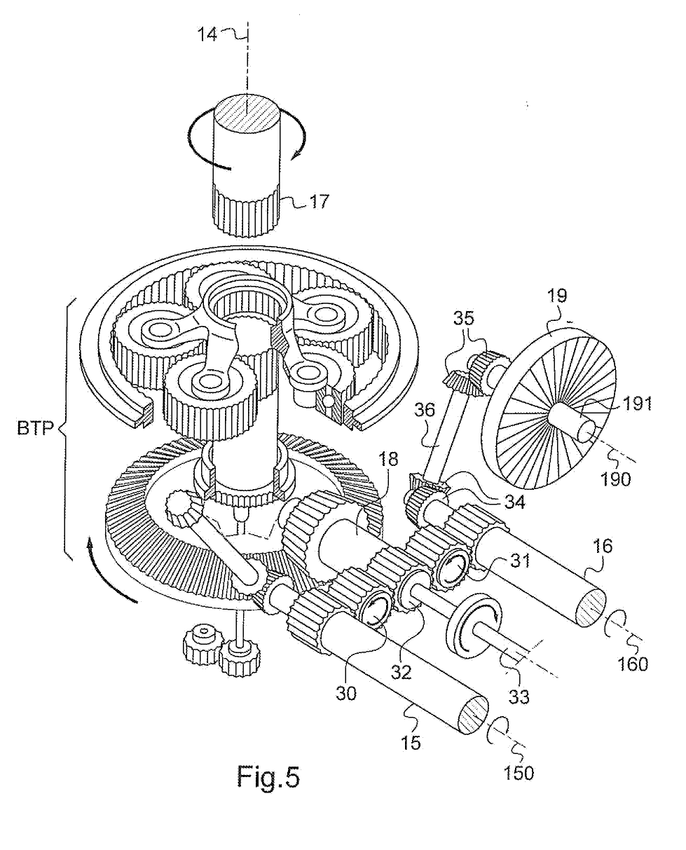

A main gearbox (MGB) acts to connect an outlet shaft 15, 16 from each engine to the shaft 17 of the main rotor, this gearbox including in particular a speed reducer (cf. FIG. 5).

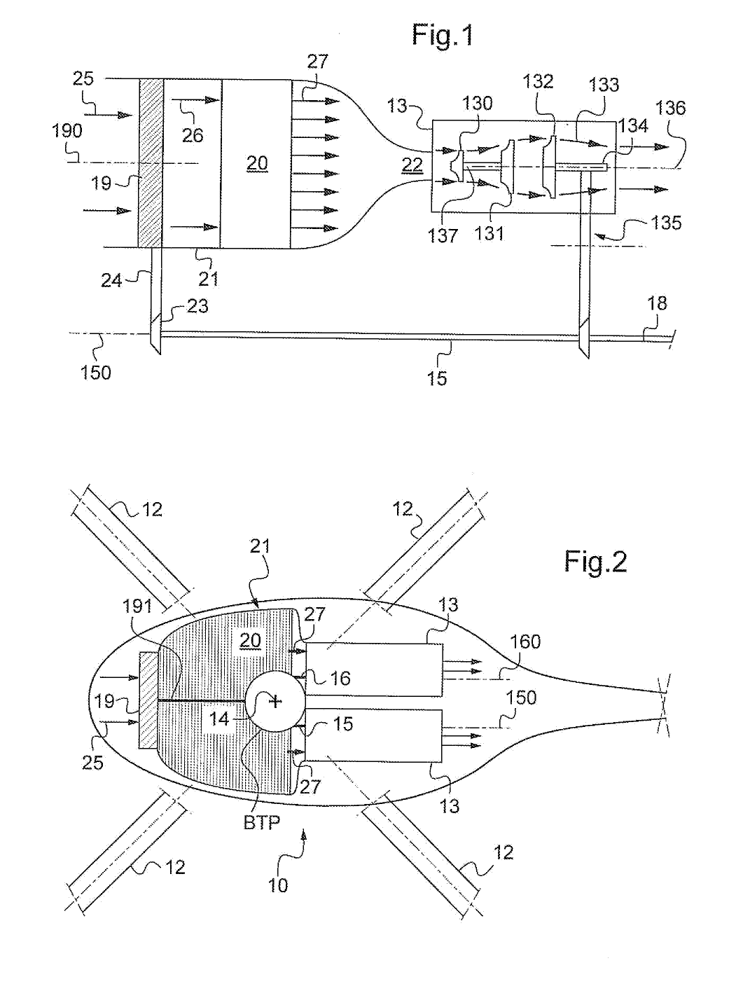

As shown in FIG. 1, each engine comprises an internal compressor 130 and a first turbine 131 constrained to rotate with the internal compressor 130. The engine also includes a free turbine 132 that is located downstream from the first turbine relative to the direction 133 in which gas flows through the engine.

The free turbine produces driving torque that is transmitted by the shaft 134 of the free turbine and then via a speed reducer 135 and by an outlet shaft 15 of the engine that extends beside and outside the engine, along an axis 150 parallel to the common axis of rotation 136 of the internal compressor 130 and of the first and second turbines 131, 132.

The engine(s) 13 thus drive(s) an inlet shaft 18 (FIGS. 1, 3, 5) of the MGB.

The power-increasing system shown in FIG. 1 comprises an external air compressor 19 that is distinct from the engine, and an air cooler 20 disposed in succession and in that order in a duct 21 for transporting air that connects the external compressor 19 to the air inlet 22 of the engine 13.

The external compressor 19 comprises a bladed wheel mounted to rotate about an axis 190 and driven in rotation by the shaft 15, via gears 23, 24 secured respectively to the shaft 15 and to the external compressor wheel.

Air 25 penetrating into the duct 21 passes through the external compressor 19, which compresses it; the compressed air 26 leaving the external compressor 19 passes through the heat exchanger 20, which cools it; and the cooled compressed air 27 leaving the heat exchanger 20 penetrates into the engine 13 via its air inlet 22.

In the embodiment corresponding to FIG. 2, the external compressor 19 is driven in rotation by a shaft 191, itself driven by the MGB that is used for driving the main rotor.

The external compressor 19 is located in front of the MGB while the two engines 13 are disposed behind the MGB; the heat exchanger 20 and the duct 21 extend in part in front of the MGB and in part on either side thereof, the duct 21 connecting the external compressor 19 to the inlets 22 of the engines 13.

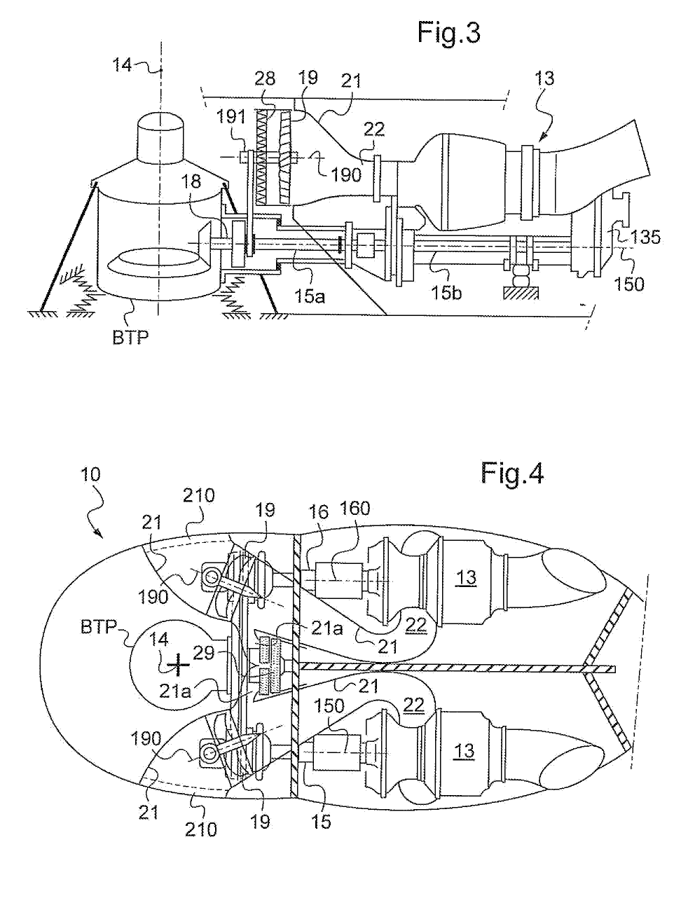

With reference to FIG. 3, two shafts 15a and 15b on the axis 150 connect the outlet from the outlet reducer 135 of the engine 13 to the inlet shaft 18 of the MGB. A transmission system, symbolized as a belt, connects the shaft 15a to the shaft 191 of the external compressor 19 so as to drive the external compressor via the outlet shaft 15a, 15b of the engine.

The bladed wheel of the external compressor is located downstream from a filter or grid 28 fitted in the air inlet of the duct 21.

In the embodiment shown in FIG. 4, the respective outlet shafts 15 and 16 from the two engines 13, extend along two respective longitudinal axes 150, 160 that are substantially parallel and horizontal, each shaft driving a respective external compressor 19.

The two external compressors 19 are disposed on either side of the MGB, behind it, close to the respective lateral air inlets 210 of the two air-transport ducts 21.

Each duct 21 is provided with a branch 21a enabling a fraction of the air compressed by each external compressor 19 to be delivered to a heat exchanger (radiator) 29 used for cooling a lubricant of the MGB.

In FIG. 4, it can be seen firstly that the outlet shafts 15, 16 from the turbine engines are “through shafts”, i.e. they extend along the respective longitudinal axes of the internal compressors and turbines of the engines, and secondly that the respective air inlets 22 of the engines are “tangential” or “lateral”.

With reference to FIG. 5, the respective outlet shafts 15, 16 from the two engines drive an inlet shaft 18 of the MGB via two gears 30, 31 meshing with the shafts 15, 16 and with another gear 32 secured to the shaft 18 and to a shaft 33 for driving an anti-torque rotor—or “tail rotor”—that is not shown.

A pair of bevel gears 34 serves to drive a shaft 36 from the shaft 16 and another pair of bevel gears 35 serves to drive the shaft 191 of the external compressor 19 from the shaft 36.

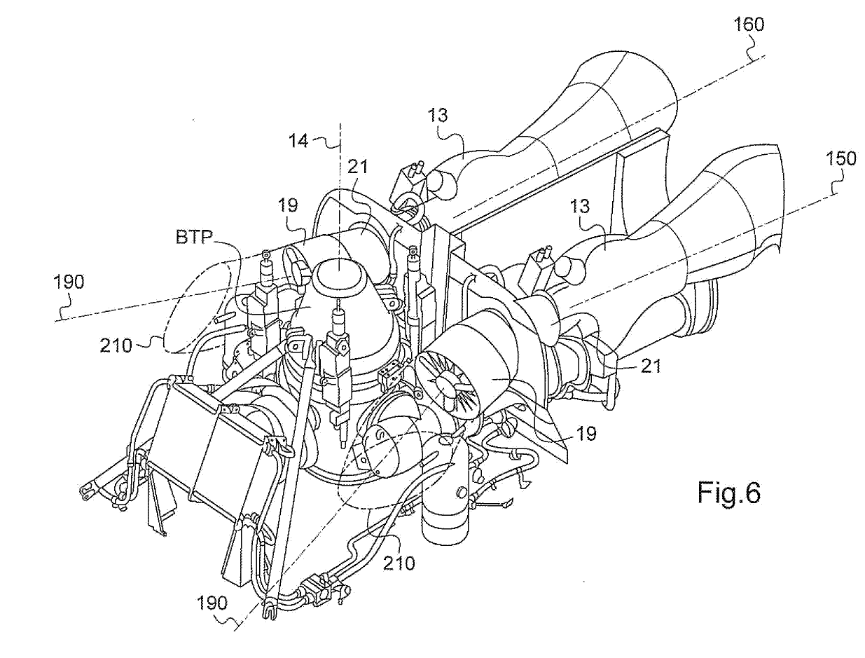

Although only one external compressor is shown in FIG. 5, which compressor is driven by the shaft 16, it will be understood that a second external compressor could be driven by the shaft 15 via a device identical to the device comprising the elements 34 to 36, in a configuration that is identical or similar to the configurations of FIGS. 4 and 6 in which the rotorcraft is fitted with two external superchargers 19 for the two engines; a part only of the device is shown in FIG. 5 in order to avoid obscuring it.

FIG. 6 shows a portion of a helicopter fitted with two external compressors 19 disposed in two ducts 21 passing to left and to right of the MGB, in front of the engines 13.

In variants not shown, each external compressor may be driven in rotation by a variable speed electric motor; furthermore, the pitch of the moving blades of the external compressor may be adjustable so as to vary the compression ratios that are obtained.

It will be understood that the above description cannot pretend to be exhaustive and that various modifications, additions, or omissions could be applied to the present invention.

What is claimed is:

1. A rotorcraft (10) comprising a main rotor (11), a turbine engine (13), a transmission mechanism (MGB) coupled to the rotor and to the engine to enable the rotor to be driven by the engine, the engine having a free turbine (132) connected to the transmission mechanism (MGB) by a shaft (15, 15a, 15b, 16, 18), the rotorcraft further comprising an external compressor (19) external to the engine (13) and arranged to be driven by the free turbine (132) or by an electric motor via said transmission mechanism (MGB), together with an air-transport duct (21) connecting the external compressor (19) to the engine to deliver the air that has been compressed by the external compressor to the inlets (22) of the engine.

2. A rotorcraft according to claim 1, wherein the external compressor (19) is arranged to be driven by the free turbine (132), via a speed reducer (135), a shaft (15, 15a, 15b, 16, 36), and the transmission mechanism (MGB).

3. A rotorcraft according to claim 1, further including a heat exchanger (20) disposed in the air-transport duct (21) between the external compressor and the engine, which heat exchanger is connected to a fluid transport circuit for cooling the air (26) that has been compressed by the external compressor.

4. A rotorcraft according to claim 1, wherein the external compressor presents, under normal conditions of temperature and pressure, for its nominal speed of rotation, a compression ratio that is situated in a range about 1.01 to about 2, and in particular in a range about 1.05 to about 1.5.

5. A rotorcraft according to claim 1, wherein the external compressor has only one bladed moving wheel, i.e. comprises a single stage, and is of the axial wheel type.

6. A rotorcraft according to claim 1, wherein the external compressor comprises a bladed moving wheel and a device for varying the pitch of the blades.

7. A rotorcraft according to claim 1, wherein the external compressor is arranged to be driven by an electric motor powered via an alternator and a battery by the engine or the MGB, and in which the external compressor includes a device for varying its speed of rotation.

8. A rotorcraft according to claim 1, wherein the engine has two outlet shafts: a first shaft on the same axis as the shaft (137) common to the internal compressor (130) and to the first turbine (131) of the engine serving to drive a propulsion propeller and/or the external compressor; and a second shaft serving to drive the main rotor of the rotorcraft via the MGB mechanism.

9. A rotorcraft according to claim 1, wherein the external compressor is situated in front of the MGB mechanism, with reference to the forward direction of the rotorcraft.

10. A rotorcraft according to claim 1, wherein the external compressor is situated behind the MGB mechanism, with reference to the forward direction of the rotorcraft.

11. A rotorcraft according to claim 1, having two engines and a single external compressor delivering pressurized air to both engines.

12. A rotorcraft according to claim 1, having two engines and two external compressors feeding respective ones of the two engines.

13. A rotorcraft according to claim 1, having two engines, and in which the air compressed by the external compressor(s) can be delivered to both engines or else to only one of them.

14. A rotorcraft according to claim 13, including a motor-driven damper disposed in the air-transporting duct(s) connecting the external compressor(s) to the engines.

15. A rotorcraft according to claim 12, wherein the external compressors are situated on either side of the MGB mechanism.

16. A rotorcraft according to claim 1, wherein the external compressor comprises a plurality of moving wheels.
